(19) United States
(12) Patent Application Publication
(10) Pub. No.: US 2026/0261447 A1
(43) Pub. Date: Sep. 3, 2026

(54) IoT Manifest

(71) Applicant: Comcast Cable Communications, LLC, Philadelphia, PA (US)

(72) Inventors: Ryan Lee McMurray, Arvada, CO (US); Jonathan Kirkovich, Parker, CO (US); Freddy Alas, Parker, CO (US)

(21) Appl. No.: 19/066,415

(22) Filed: Feb. 28, 2025

(51) Int. Cl. H04L 12/28; G16Y 40/30

(52) U.S. Cl. CPC H04L 12/2814; G16Y 40/30

(57) ABSTRACT

Systems, apparatuses, and methods are described for providing an auxiliary data track within a content manifest for controlling IoT devices. A content may be requested by a first device. A manifest file, associated with the content, may be received by the first device. The manifest file, comprising data for controlling IoT devices, may be forwarded to a second device.

### BACKGROUND

Internet of Things (IoT) devices may connect in a smart home environment and communicate with other devices. A user may control the IoT devices based on user preferences.

### SUMMARY

The following summary presents a simplified summary of certain features. The summary is not an extensive overview and is not intended to identify key or critical elements.

Media content may be requested by a first device. A manifest file, associated with the content media, may be received by the first device. The manifest file, for example, indicating data for controlling IoT devices, may be forwarded to a second device (e.g., environment hub). The second device may request the data for controlling the IoT devices. The data may comprise time information for synchronizing with the content media, and may be used for generating commands for controlling the IoT devices. The commands, executed by the IoT device, may synchronize with the content media.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIGS. 3A, 3B, 3C, 3D, 3E, 3F, 3G, and 3H shows example flow diagrams associated with elements of a communication network.

FIGS. 4A, 4B, and 4C show a timeline showing an example of providing an auxiliary data track with instructions for controlling IoT devices.

FIG. 5 shows an example format of a manifest file.

FIG. 6 shows an example of a manifest file.

FIG. 7 shows an example format of a control file.

FIG. 8A shows an example of a control file.

FIG. 8B shows an example map indicating locations of IoT devices and an environment hub.

FIG. 9 shows an example method associated with controlling IoT devices.

FIG. 10 shows an example method associated with controlling IoT devices.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

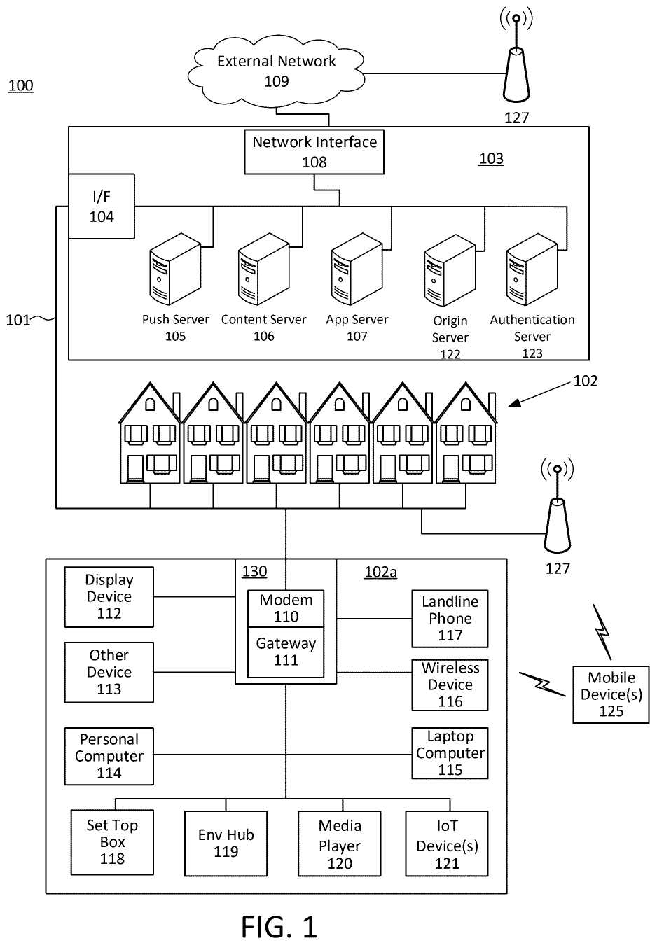

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, offices, shopping malls, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as push server 105, content server 106, application server 107, origin server 122 and/or authentication server 123 to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, for example, via one or more of the wireless access points 127.

The set top box 118 may be a video streaming device, a digital video recorder (DVR), a digital transport adapter (DTA), a computer server, and/or any other desired computing device. The set top box 118 may communicate with an environment hub 119, IoT device(s) 121 (e.g., user devices) and a gateway 111, via a wired or wireless network.

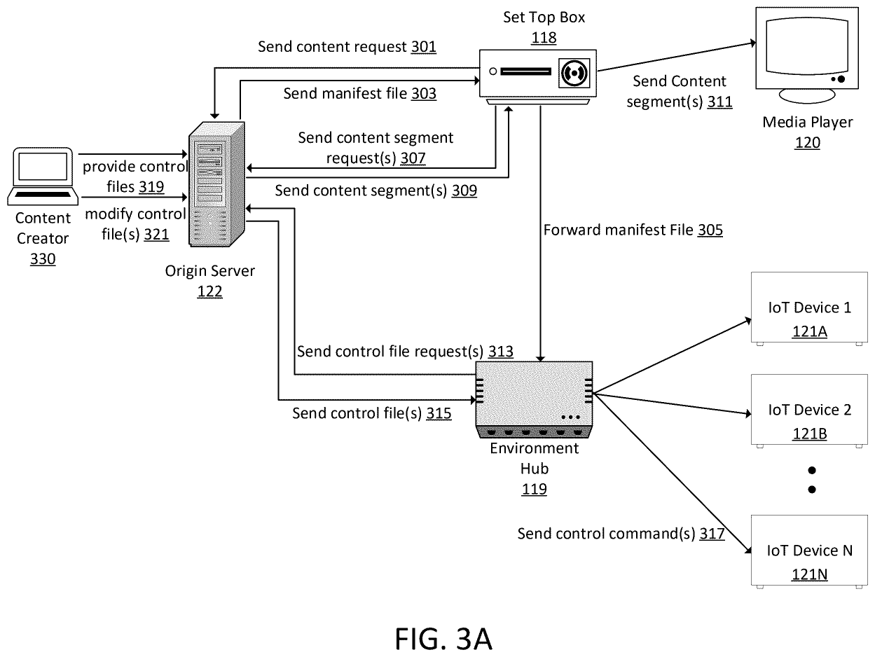

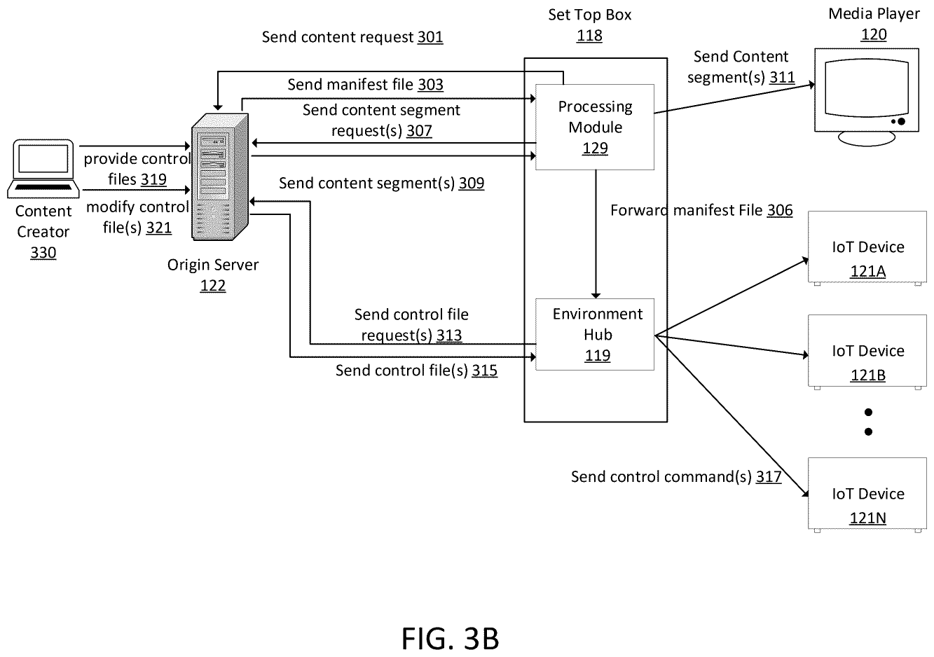

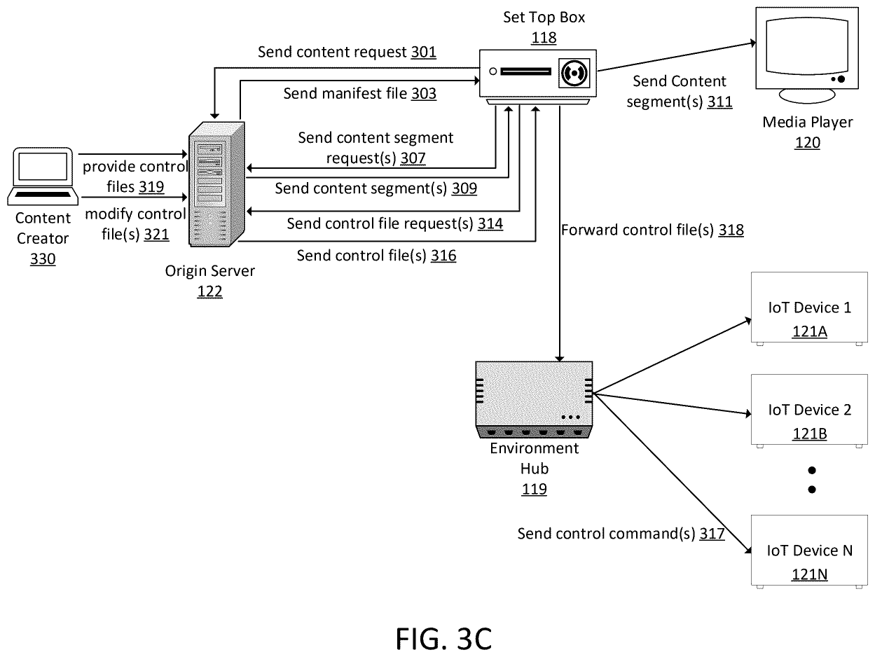

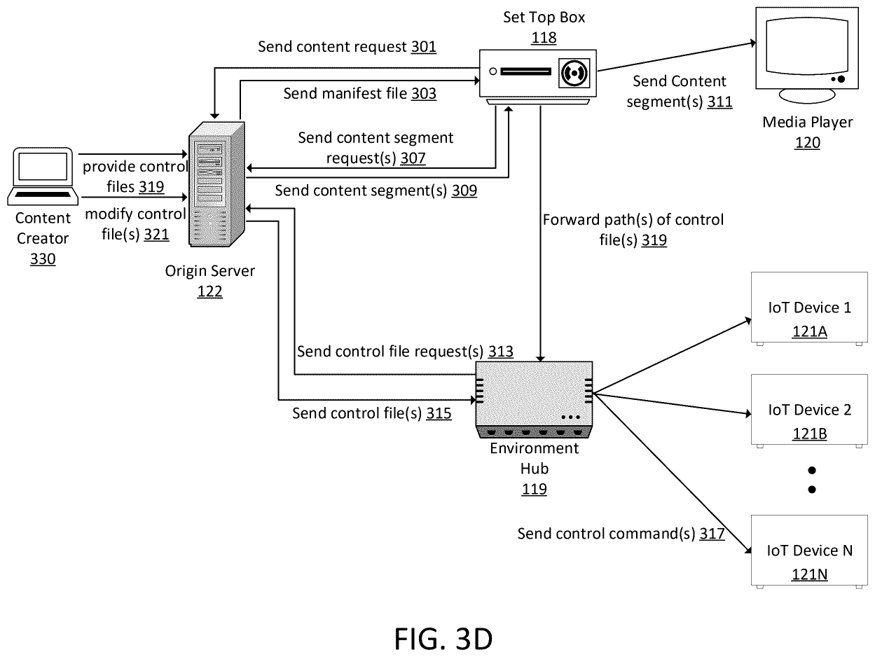

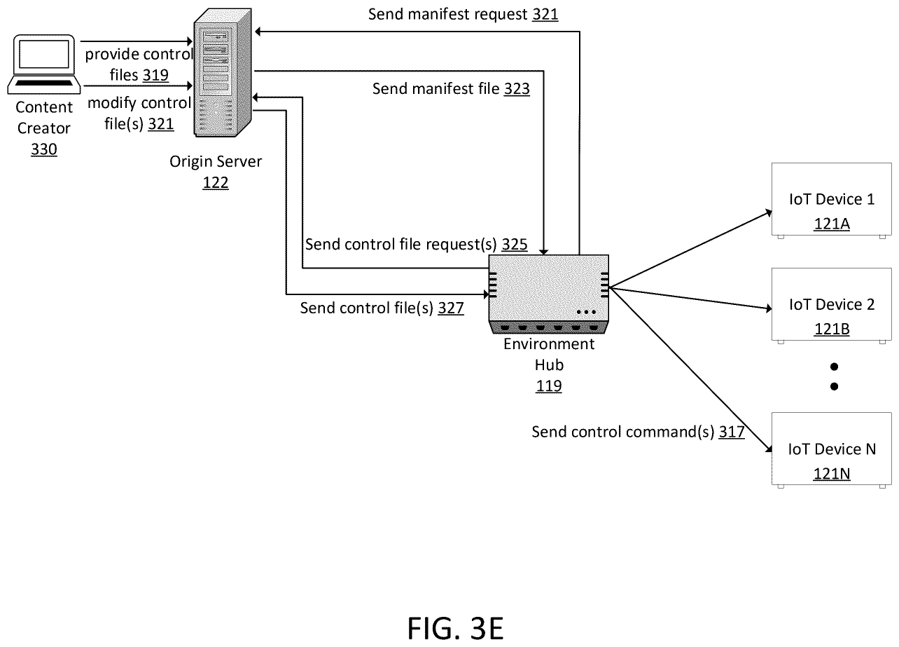

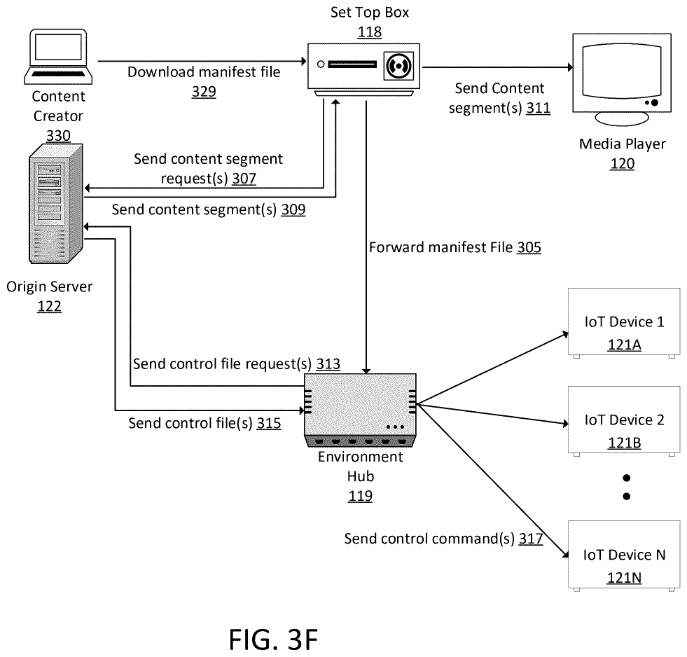

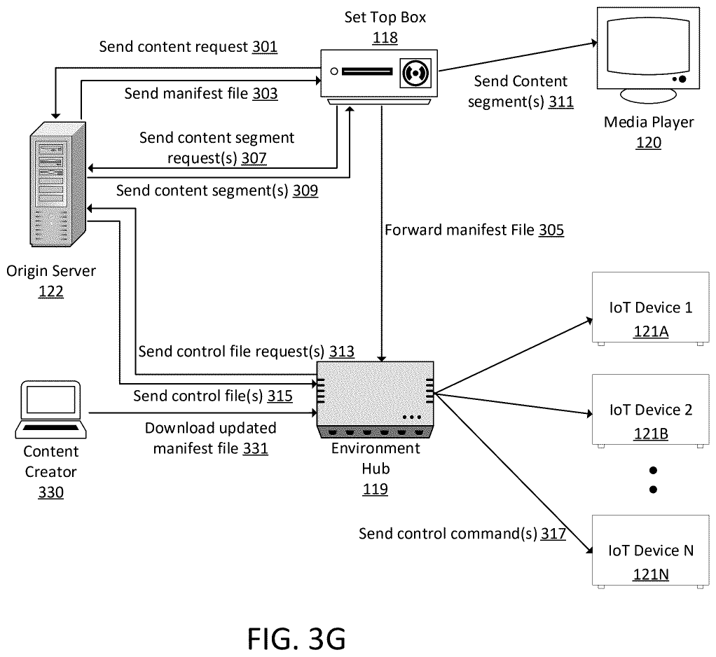

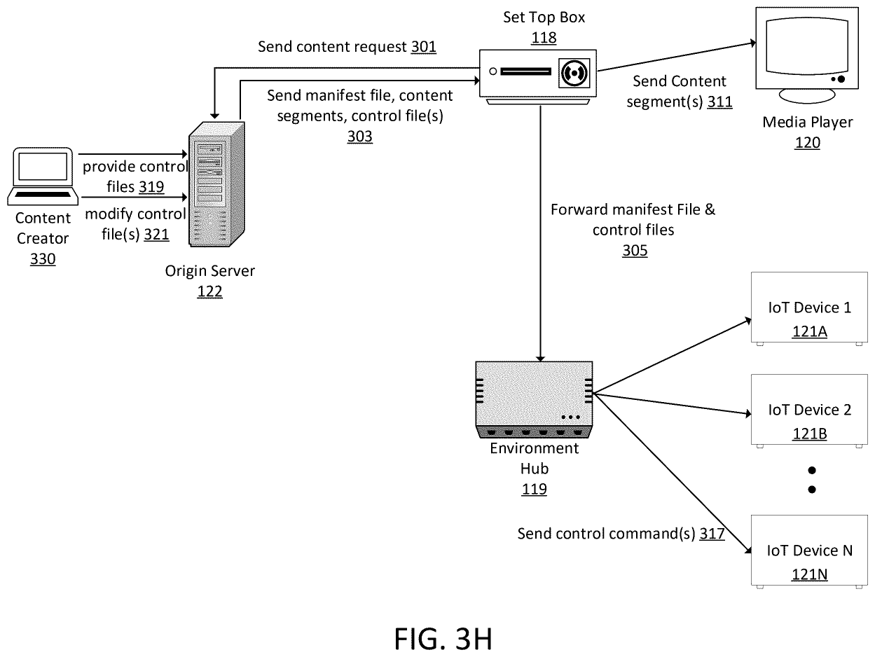

The environment hub 119 may be a desktop computer, a laptop, a mobile phone, a smartphone, a tablet, a mobile television, a personal digital assistant (PDA), etc. The environment hub 119 may communicate with the set top box 118, the IoT device(s) 121 and the gateway 111, via a wired or wireless network. Although shown separately in FIG. 3B, the set top box 118 and environment hub 119 may be combined. The set top box 118 may comprise environment hub 119, for example, so that the set top box 118 may run the functions of the environment hub 119.

The IoT device(s) 121 may be smart light bulbs, lighting devices, vibrating device (e.g., a sofa or chair with vibrating function), fragrance diffusing devices, smart displays, smart TVs, smart thermostats, door locks, mobile phones, smartphones, tablets, personal digital assistants (PDA), smart appliances (e.g., oven, refrigerator, microwave, air fryer, toaster, dishwasher, coffee maker, washer, dryer), electric car chargers, smart garage door openers, smart smoke detectors, smart speakers, smart mirrors, robot vacuums, etc. The IoT device(s) 121 may communicate with the set top box 118, the environment hub 119 and the gateway 111, via a wired and/or wireless network.

An example premises 102a may comprise an interface 130. The interface 130 may comprise circuitry used to communicate via the communication links 101. The interface 130 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), a twisted-pair telephone modem, a wireless transceiver, and/or any other desired modem device. One modem is shown in FIG. 1, but a plurality of modems operating in parallel may be implemented within the interface 130. The interface 130 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), a digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions, smart TVs), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA), virtual reality devices), landline phones 117 (e.g., Voice over Internet Protocol—VoIP phones) and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 130 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

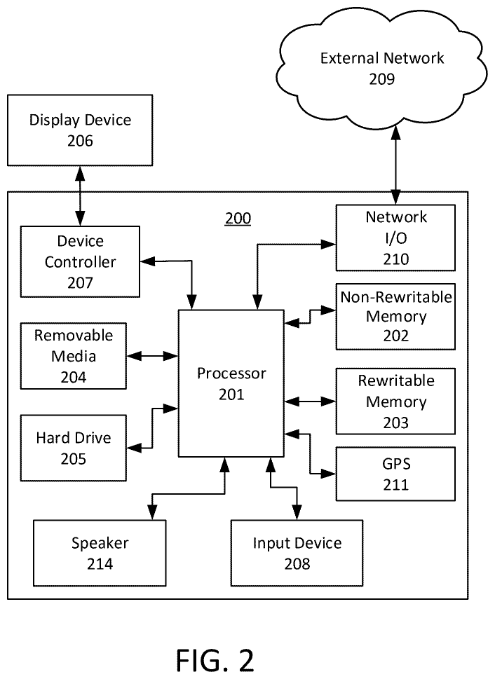

FIG. 2 shows hardware elements of a computing device 200 that may be used to implement any of the computing devices shown in FIG. 1, for example, the mobile devices 125, any of the devices shown in the premises 102a (including set top box 118, environment hub 119, media player 120, IoT device(s) 121 (e.g., user device)), any of the devices shown in the local office 103 (including origin server 122 and authentication server 123), any of the wireless access points 127, any devices with the external network 109) and any other computing devices discussed herein. The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, camera, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

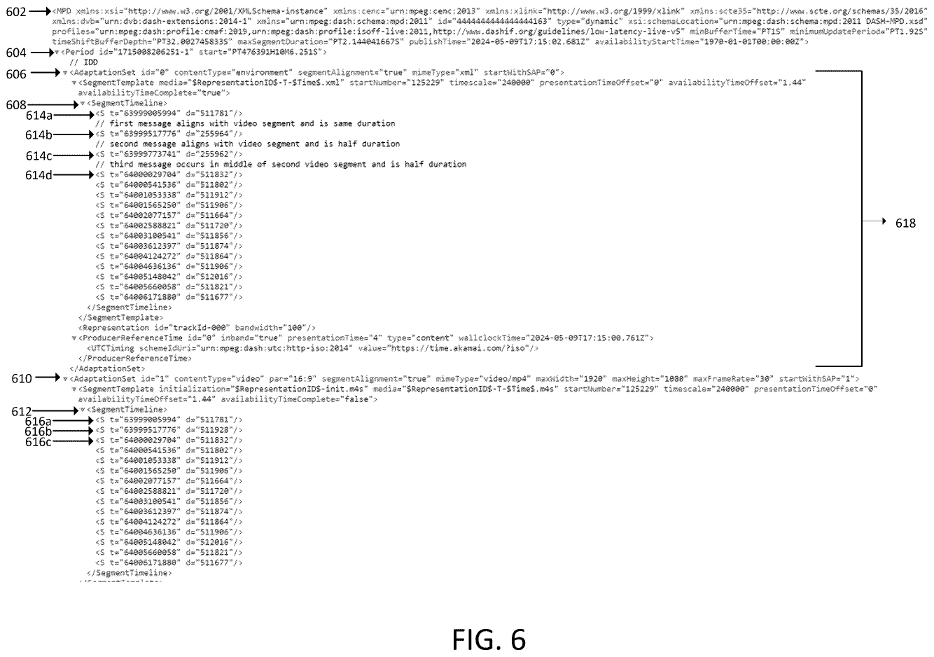

FIG. 3A shows an example flow diagram associated with elements of the communication network 100. In particular, FIG. 3A shows example elements of communication network 100 that may be used to provide, together with a content manifest, an auxiliary data track with instructions for controlling IoT devices 121A-121N (e.g., user device). At step 301, a set top box 118 may send a content request to an origin server 122. The auxiliary data track (e.g., an example of auxiliary data track 618 in FIG. 6) may comprise environment effect data for receiving control commands (e.g., from origin server 122), wherein the control commands may be used to control the IoT devices 121A-121N. The content request may be sent based on a content selection by a user via an interface of the set top box 118. For example, the user may use a remote control to select a video for reviewing. The interface of the set top box 118 may not be limited to the remote control, and may be a graphic user interface (GUI) (e.g., a touch screen) or a voice control. Content may be audio and/or video. The content request may comprise one or more identifiers of the content, and/or one or more indications of the IoT devices 121A-121N. The one or more identifiers of the content may include a title, a catalog identifier (comprising numbers and/or letters), and/or a path of the content. The one or more indications of the IoT devices 121A-121N may include a device type, a device status, and/or a device model number.

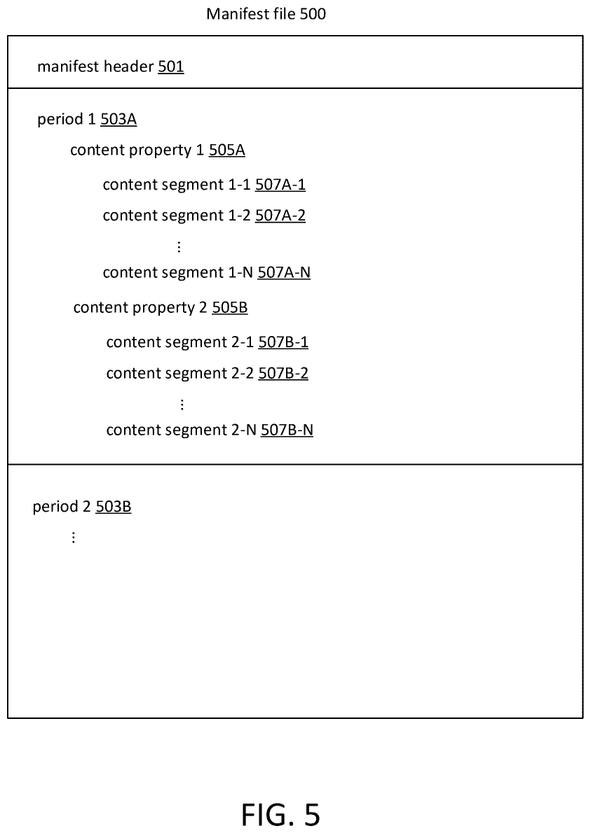

An origin server 122 may receive and parse the content request. The origin server 122 may parse the content request to determine the requested content and the one or more indications of the IoT devices 121A-121N. The origin server 122 may map content streams from content source(s), where the content source(s) may be stored in the origin server 122 or different from the origin server 122. The origin server 122 may determine content properties, such as, for example, a content output format, a segment duration, a content type, a resolution, a bandwidth, a base content pointer (e.g., URL), and/or a segment index. The content type may be video, audio, or environment type, where the environment type content may be associated with data for controlling the IoT devices 121A-121N. The origin server 122 may use the content properties to generate a manifest file, for example, as shown in the examples of FIG. 5 and FIG. 6. Content properties associated with the environment content type may, for example, based on the one or more indications of the IoT devices 121A-121N, be added to the manifest file. At step 303, the origin server 122 may send the generated manifest file to the set top box 118.

The set top box 118 may parse the manifest file, for example, after receiving the manifest file at step 303. The manifest file may comprise one or more of the content properties associated with the content types. The set top box 118 may determine the content types by parsing the manifest file. The set top box 118 may use the content properties, for example, associated with the video content type or audio content type, to request content segments. The set top box 118 may generate a request, for a first segment content, with properties such as, for example, a content output format, a content type, a resolution, a bandwidth, a base content pointer, and/or an initial segment index. At step 307, the set top box 118 may send the content segment request to the origin server 122. At step 309, the origin server 122 may, based on the content segment request, send the content segment to the set top box 118. The set top box 118 may change the segment index for subsequent segment requests. The set top box 118 may change resolution and/or bandwidth for subsequent segment requests, for example, depending on an available network bandwidth. At step 311, the set top box 118 may output (e.g., send) the content segments to a media player 120, for example, after the set top box 118 receives the content segments from the origin server 122. The sent content segments may be played by the media player 120.

At step 305, the set top box 118 may forward the manifest file to the environment hub 119, for example, if the set top box 118 detects content properties associated with the environment content type in the manifest file. At step 313, the environment hub 119 may send a control file request to the origin server 122, for example, after the environment hub 119 receives the forwarded manifest file. The control files may be used to control the IoT devices 121A-121N. The environment hub 119 may generate a first control file request, for example, based on a first segment index associated with the environment content type. The environment hub 119 may change the segment index for subsequent control file requests. The segment indexes associated with the environment content type may be synchronized with the segment indexes associated with the audio and video content types. The control file request may comprise a path of the control file (e.g., URL of the control file). The determination of the path of the control file is discussed in additional detail with reference to FIG. 6. The environment hub 119 may send the generated control file request(s) to the origin server 122. At step 315, the origin server 122 may, for example, based on the received control file request(s), send the control file(s) to the environment hub 119. The environment hub 119 may, based on the received control files, generate control command(s). The control command(s) may be used to control operations of the IoT devices 121A-N, such as, for example, light luminance, light colors, seat vibrations, dispensing fragrance, adjusting thermostat temperature, capturing videos and/or images, playing audio, videos and/or images from live or pre-recorded source(s), sending messages, opening a door and/or garage door, ringing doorbell, activating and/or deactivating appliances, etc. At step 317, the environment hub 119 may send the generated control command(s) to one or more of the IoT devices 121A-121N. The control command(s) may be sent to the IoT devices 121A-121N in synchronization with the content segments sent to the media player 120, for example, based on the control command(s) and content segments being sent according to the segment index. Users may enjoy the matching environment effect by the IoT devices associated with the corresponding video/audio segment. For example, the set top box 118 may send a content segment, associated with a segment index (e.g., t=“399905994”), to the media player 120. The environment hub 119 may send control command(s), associated with the same segment index (e.g., t=“6399905994”), to the IoT devices 121A-121N.

Additionally or alternatively, a corresponding clock in the set top box 118 and the environment hub 119 may be synchronized with a common clock in origin server 122 or other source(s) (e.g., a clock server) so that, at about the same time, the set top box 118 may send the content segment, and the environment hub 119 may send the corresponding control command(s). The set top box 118 may send a synchronization message to the environment hub 119, for example, if the set top box 118 needs additional time to buffer the content segment. The synchronization message may indicate a delay time, for example, where the environment hub 119 may delay sending the control command(s), so that the content segment and control command(s) may be sent out at about the same time. For example, the control command(s) may be sent after a time period corresponding to the delay time. The control command(s) may be synchronized such that the IoT devices 121A-121N may execute the control command(s) at about the same time.

Additionally or alternatively, a corresponding clock in the set top box 118 and the IoT devices 121A-121N may be synchronized with a common clock in origin server 122 or other source(s) (e.g., a clock server) so that, at about the same time, the control command(s) may be executed, by the IoT devices 121A-121N, at about the same time with the content segment played by the media player 120. The set top box 118 may send a synchronization message to the IoT devices 121A-121N, for example, if the set top box 118 needs additional time to buffer the content segment. The synchronization message may indicate a delay time, for example, where IoT devices 121A-121N may delay executing the control command(s). The control command(s) may be synchronized such that IoT devices 121A-121N may execute the control command(s) at about the same time as the content segment is played at media player 120.

Additionally or alternatively, at step 303, the origin server 122 may send the manifest file and control file(s) to the set top box 118. The manifest file and control file(s) may be sent to the set top box 118 in combination. The manifest file and control file(s) may be sent to the set top box 118 separately. At step 305, the set top box 118 may forward the manifest file and control file(s) to the environment hub 119, for example, if the set top box 118 detects content properties associated with the environment content type in the manifest file. In one example, control command(s), instead of the control file(s), may be sent in combination with or separately from the manifest file at step 303. The manifest file and control command(s) may be forwarded at step 305.

Content creator 330 may provide the content to the origin server 122. At step 319, the content creator 330 may provide control files, associated with the content, to the origin server 122. At step 321, the content creator 330 may modify the provided control files. For example, the content creator 330 may provide an alternative (e.g., “director's cut”) control file. The providing and modification of the control files are not limited by the content creator 330. For example, a third party, such as a manufacturer(s) of the IoT devices 121A-121N and/or fans of the content, may contribute to providing and/or modifying the control files. The origin server 122 may authenticate an authorization of the third party (e.g., username and/or password) before the third party can contribute to providing and/or modifying the control files. After authentication, the origin server 122 may replace the modified control files or update paths of the modified control files (e.g., URL of the modified control files) for retrieval (e.g., modifying segment template in section 606).

FIG. 3B shows an example flow diagram associated with elements of the communication network 100. In FIG. 3B, the environment hub 119 may not be a standalone device. The environment hub 119 may be part of the set top box 118. The set top box 118 may comprise a processing module 129 performing the steps 301, 303, 307, 309, and 311 as described in FIG. 3A. Forwarding of the manifest file at step 306 may be an internal messaging step, for example, performed within the set top box 118. At step 306, the processing module 129 may forward the manifest file to the environment hub 119, for example, if the set top box 118 detects content properties associated with the environment content type in the manifest file. The environment hub 119 may perform the steps 313, 315, and 317 as described in FIG. 3A. The processing module 129 and the environment hub 119 may be implemented by processor 201 as described in FIG. 2. The content creator 330 may perform the steps 319, and 321 as described in FIG. 3A.

Additionally or alternatively, at step 303, the origin server 122 may send the manifest file and control file(s) to the processing module 129. The manifest file and control file(s) may be sent to the set top box 118 in combination. The manifest file and control file(s) may be sent to the processing module 129 separately. At step 306, the processing module 129 may forward the manifest file and control file(s) to the environment hub 119, for example, if the processing module 129 detects content properties associated with the environment content type in the manifest file. In one example, control command(s), instead of the control file(s), may be sent in combination with or separately from the manifest file at step 303. The manifest file and control command(s) may be forwarded at step 306.

FIG. 3C shows an example flow diagram associated with elements of the communication network 100. In the example of FIG. 3C, the set top box 118 may forward the control file(s), instead of the manifest file, to the environment hub 119 as described in FIG. 3A. The set top box 118 may perform the steps 301, 303, 307, 309, and 311 as described in FIG. 3A. At step 314, the set top box 118 may send control file request(s) to the origin server 122, for example, if the set top box 118 detects content properties associated with the environment content type in the manifest file. The control files may be used to control the IoT devices 121A-121N. The set top box 118 may generate a first control file request based on a first segment index associated with the environment content type. The set top box 118 may change the segment index for subsequent control file requests. The segment indexes associated with the environment content type may be synchronized with the segment indexes associated with the audio and video content types. Each control file request may comprise a path of the control file (e.g., URL of the control file). The determination of the path of the control file is discussed in additional detail with reference to FIG. 6. The set top box 118 may send the generated control file request(s) to the origin server 122. At step 316, the origin server 122 may, for example, based on the received control file request(s), send the control file(s) to the set top box 118. At step 318, the set top box 118 may forward the control file(s) to the environment hub 119. The environment hub 119 may perform the step 317 as described in FIG. 3A, for example, after (e.g., based on) receiving the control file(s) from the set top box 118. The content creator 330 may perform the steps 319, and 321 as described in FIG. 3A.

Additionally or alternatively, at step 303, the origin server 122 may send the manifest file and control file(s) to the set top box 118. The manifest file and control file(s) may be sent to the set top box 118 in combination. The manifest file and control file(s) may be sent to the set top box 118 separately. At step 318, the set top box 118 may forward the control file(s) to the environment hub 119, for example, if the set top box 118 detects content properties associated with the environment content type in the manifest file. In one example, control command(s), instead of the control file(s), may be sent in combination with or separately from the manifest file at step 303. The control command(s), instead of the control file(s), may be forwarded at step 318.

FIG. 3D shows an example flow diagram associated with elements of the communication network 100. In the example of FIG. 3D, the set top box 118 may forward the path(s) of the control file(s) (e.g., URL of the control file(s)) instead of the manifest file to environment hub as described in FIG. 3A. The set top box 118 may perform the steps 301, 303, 307, 309, and 311 as described in FIG. 3A. Step 314 may be performed after (e.g., based on) the origin server 122 sends the manifest file to the set top box 118 at step 303. At step 319, the set top box 118 may forward the path(s) of the control file(s) to the environment hub 119. The forwarding path(s) of the control file(s) may comprise determining the path(s) of the control file(s). The set top box 118 may determine the path(s) of the control file(s) (e.g., URL(s) of the control file(s)), for example, if the set top box 118 detects content properties associated with the environment content type in the manifest file. The determination of the path(s) of the control file(s) is discussed in additional detail with reference to FIG. 6. At step 319, the set top box 118 may forward the determined path(s) of the control file(s) to the environment hub 119. The environment hub 119 may perform the steps 313, 315, and 317 as described in FIG. 3A. The environment hub 119 may not need to determine the path(s) of the control file(s) because the path(s) may already be determined and forwarded by the set top box 118. The content creator 330 may perform the steps 319 and 321 as described in FIG. 3A.

FIG. 3E shows an example flow diagram associated with elements of the communication network 100. In the example of FIG. 3E, the environment hub 119 may send a manifest request (e.g., a request for a manifest file) and receive the manifest file. At step 321, the environment hub 119 may send a manifest request to the origin server 122. The manifest request may be sent based on a non-audio/video playing event to the user (e.g., the user not playing any video and/or audio content through the set top box 118). The manifest request may comprise one or more identifiers of the non-audio/video playing event and/or one or more indications of the IoT devices 121A-121N. The origin server 122 may parse the manifest request to determine the requested non-audio/video playing event and the one or more indications of the IoT devices 121A-121N. The origin server 122 may determine the content type as the environment type. The origin server 122 may use the environment-type properties to generate a manifest file, for example, as shown in auxiliary data track 618 in FIG. 6. Content properties associated with the environment content type may, for example, based on the one or more indications of the IoT devices 121A-121N, be added to the manifest file. At step 323, the origin server 122 may send the generated manifest file to the environment hub 119. The environment hub 119 may parse the manifest file, for example, after (e.g., based on) receiving the manifest file. At step 325, the environment hub 119 may send a control file request to the origin server 122, for example, if the environment hub 119 detects content properties associated with the environment content type in the manifest file. The control files may be used to control IoT devices 121A-121N. The environment hub 119 may generate a first control file request based on a first segment index associated with the environment content type. The environment hub 119 may change the segment index for subsequent control file requests. Each control file request may comprise a path of the control file (e.g., URL of the control file). The determination of the path of the control file is discussed in additional detail with reference to FIG. 6. At step 327, the origin server 122 may, for example, based on the received control file request(s), send the control file(s) to the environment hub 119. The step 317 may be performed after the control file(s) are received by the environment hub 119. The environment hub 119 may perform the step 317 as described in FIG. 3A. The content creator 330 may perform the steps 319, and 321 as described in FIG. 3A.

Additionally or alternatively, at step 323, the origin server 122 may send the manifest file and control file(s) to the environment hub 119. The manifest file and control file(s) may be sent to the set top box 118 in combination. The manifest file and control file(s) may be sent to the set top box 118 separately. In one example, control command(s), instead of the control file(s), may be sent in combination with or separately from the manifest file at step 323.

FIG. 3F shows an example flow diagram associated with elements of the communication network 100. In the example of FIG. 3F, the set top box 118 may download a manifest file from the content creator 330. The user may wish to play an alternative version (e.g., “director cut” version) of the content, for example, as described in FIG. 3A. At step 329, the set top box 118 may download a manifest file from the content creator 330, for example, based on a selection by the user via the interface of the set top box 118. The downloaded manifest file may be distinct from the manifest file sent from the origin server 122. For example, the downloaded manifest file may be associated with the alternative version (e.g., “director cut”) of the content, and the manifest file sent from the origin server 122 may be associated with an original version of the content. The downloaded manifest file may indicate a different version of video, audio, and/or environment effect data content. The set top box 118 may perform the steps 305, 307, 309, and 311 as described in FIG. 3A, for example, after (e.g., based on) the set top box 118 downloads the manifest file from the content creator 330 at step 329. The environment hub 119 may perform the steps 313, 315, and 317 as described in FIG. 3A.

Additionally or alternatively, at step 329, the manifest file and control file(s) may be downloaded. At step 305, the set top box 118 may forward the manifest file and control file(s) to the environment hub 119, for example, if the set top box 118 detects content properties associated with the environment content type in the manifest file. In one example, the manifest file and control command(s) may be downloaded at step 329. The manifest file and control command(s) may be forwarded at step 305.

FIG. 3G shows an example flow diagram associated with elements of the communication network 100. In the example of FIG. 3G, the set top box 118 may download a manifest file from the content creator 330. The set top box 118 may perform the steps 301, 303, 305, 307, 309, and 311 as described in FIG. 3A. The environment hub 119 may perform the steps 313, 315, and 317 as described in FIG. 3A. The user may wish to play an alternative version of the environment effect data content for the IoT devices 121A-121N. At step 331, the environment hub 119 may download an updated manifest file from the content creator 330. The download may be initiated based on a selection by a user via an interface of the environment hub 119. For example, the user may use a remote control to select the download. The interface of the environment hub 119 may not be limited to the remote control, and may be a graphic user interface (GUI) (e.g., a touch screen) or a voice control. The downloaded manifest file may overwrite the forwarded manifest file at step 305. The downloaded manifest file may indicate an alternative version of the environment effect data. The environment hub 119 may send control file request(s) based on the downloaded manifest file, and may receive an alternative version of control file(s) from the origin server 122. The environment hub 119 may send control comment(s), based on the alternative version of control file(s), to the IoT devices 121A-121N.

FIG. 3H shows an example flow diagram associated with elements of the communication network 100. In the example of FIG. 3H, at step 301, the set top box 118 sends a content request. At step 303, the origin server 122 may send a manifest file, content segments and control file(s) to the set top box 118. The manifest file, content segments and control file(s) may be sent to the set top box 118 in combination or separately. The set top box 118 may perform the step 311 as described in FIG. 3A. The environment hub 119 may perform the step 317 as described in FIG. 3A. The origin server 122 may perform the steps 319, and 321 as described in FIG. 3A.

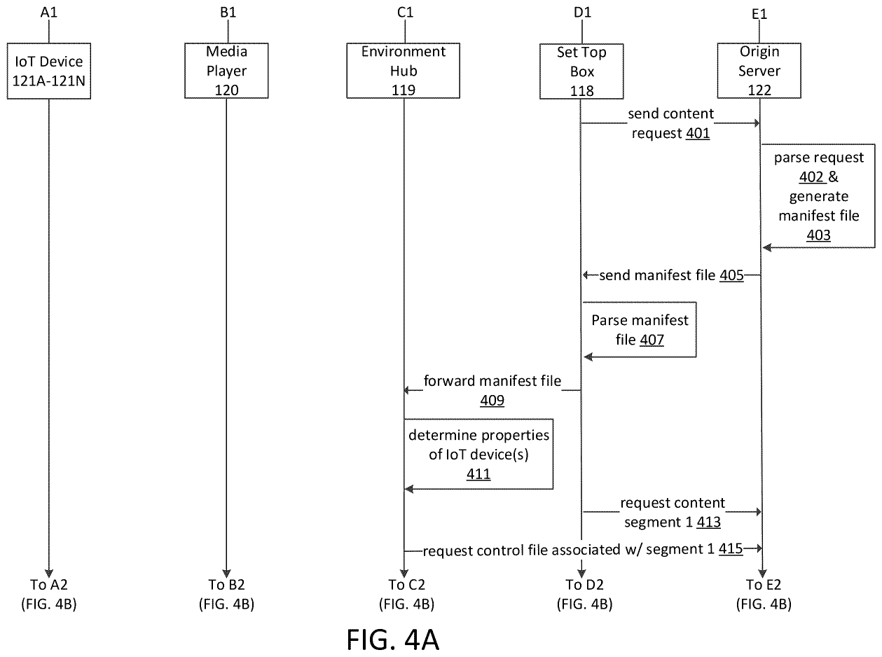

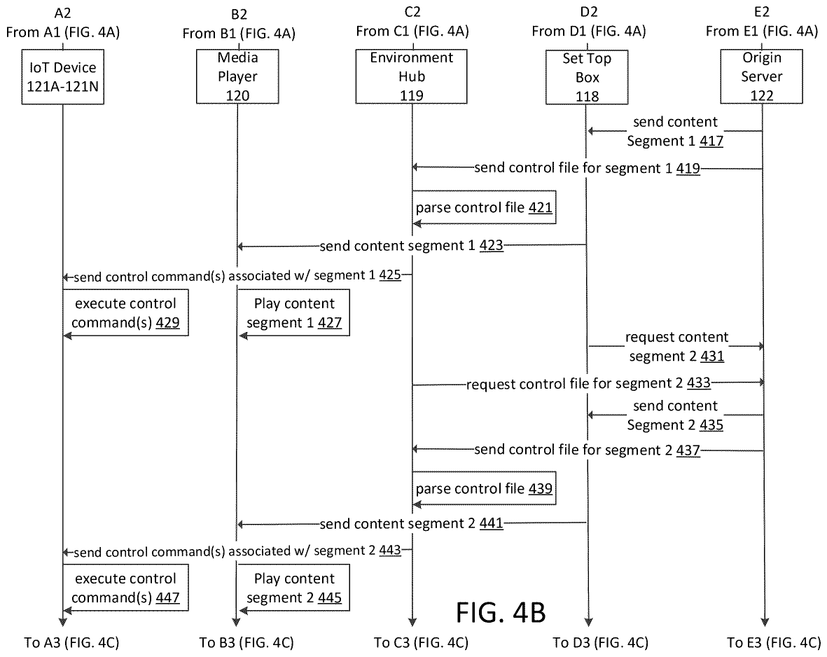

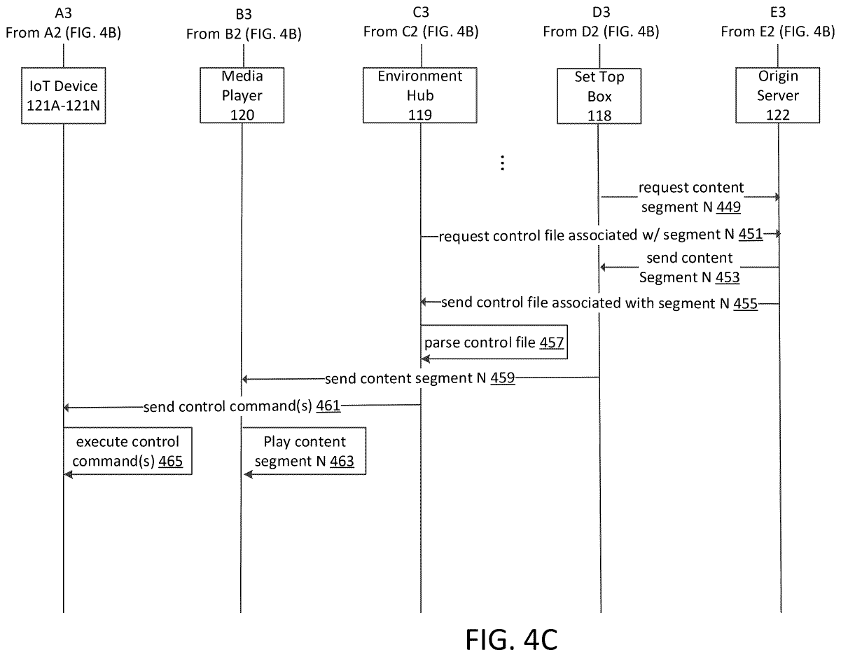

FIGS. 4A, 4B, and 4C show a timeline showing an example of providing an auxiliary data track with instructions for controlling IoT devices 121A-121N (e.g., user devices). At step 401, a set top box 118 may send a content request to an origin server 122. The content (e.g., that has been requested) may be, for example, audio and/or video. The content request may comprise one or more identifiers of the content and/or one or more indications of the IoT devices 121A-121N. The one or more identifiers of the content may include, for example, a title, a catalog identifier (e.g., comprising numbers and/or letters), and/or a path of the content (e.g., URL of the content). The one or more indications of the IoT devices 121A-121N may include a device type, a device status, and/or a device model number.

At step 402, the origin server 122 may parse the content request. The origin server 122 may parse the content request to determine the requested content and the one or more indications of the IoT devices 121A-121N. The origin server 122 may map content streams from content source(s), where the content source(s) may be stored in the origin server 122 or different from the origin server 122. The origin server 122 may determine content properties, such as, for example, a content output format, a segment duration, a content type, a resolution, a bandwidth, a base content pointer (e.g., URL), and/or a segment index. The content type may be one or more of video, audio, or environment type, where the environment type may be associated with data controlling the IoT devices 121A-121N. At step 403, the origin server 122 may use the content properties to generate the manifest file as shown in the examples of FIG. 5 and FIG. 6. Content properties associated with the environment content type may, for example, based on the one or more indications of the IoT devices 121A-121N, be added to the manifest file. At step 405, the origin server 122 may send the generated manifest file to the set top box 118.

The set top box 118 may receive the manifest file. At step 407, the set top box 118 may parse the received manifest file. The manifest file may comprise the content properties associated with the content types. The set top box 118 may determine the content types by parsing the manifest file. At step 409, the set top box 118 may forward the manifest file to the environment hub 119, for example, if the set top box 118 detects content properties associated with the environment content type in the manifest file.

At step 411, the environment hub 119 may determine the properties of the IoT device(s) 121A-121N. The properties may comprise, for example, a device power status, a device type, and/or a device operation range. The device operation range may indicate the operation range of the device. For example, one of the IoT devices 121A-121N may be a lighting device, and the device operation range may indicate the range of color (e.g., 2500 kelvin-5000 kelvin) and/or luminance.

The set top box 118 may generate a request for a first content segment. The request may comprise content properties such as a content output format, a content type, a resolution, a bandwidth, a base content pointer, and/or one or more segment indexes. At step 413, the set top box 118 may send the content segment request to the origin server 122.

At step 415, the environment hub 119 may request a control file, associated with the first environment content segment, from the origin server 122. The control file may be used to control one or more of the IoT devices 121A-121N. The environment hub 119 may generate a control file request for the first environment content segment, where the control file request may comprise the segment index for the first environment content segment. The environment hub 119 may send the generated control file request to the origin server 122.

Referring to FIG. 4B, at step 417, the origin server 122 may, for example, based on the received content segment request, send the first content segment to the set top box 118. At step 419, the origin server 122 may, for example, based on the received control file requests, send the control file for the first environment content segment to the environment hub 119. At step 421, the environment hub 119 may parse the control file and generate control commands for the IoT devices 121A-121N. The control commands may be used to control operations of the IoT devices 121A-121N, such as, for example, light luminance, light colors, seat vibrations, fragrance dispensing, etc. The environment hub 119 may, based on the parsed control file and the determined device properties (e.g., threshold properties), generate control command(s) for the IoT devices 121A-121N. The generated control command(s) may be adjusted based on the determined device properties. For example, the maximum threshold operating luminance associated with an IoT device (e.g., one of the IoT device 121A-121N) may be 50 candela per square meter (cd/m²). The environment hub 119 may lower the luminance to 50 cd/m² for the control command even if the control file indicates a luminance setting of 70 cd/m².

At step 423, the set top box 118 may output (e.g., send) the first content segment to the media player 120. At step 425, the environment hub 119 may send the control command(s) associated with the first content segment. The control command(s) may be sent to and/or received by the IoT devices 121A-121N, for example, in synchronization with the content segments sent to media player 120, for example, because the control commands and content segments may be sent at about the same time according to the segment index. For example, the set top box 118 may send the first content segment, associated with segment index (e.g., t=“399905994”), to the media player 120. Similarly, the environment hub 119 may send the control command(s), associated with the same segment index (e.g., t=“399905994”), to the controlled IoT devices 121A-121N. In an example configuration, the environment hub 119 may send the control command(s) at about the same time the set top box 118 sends the first content segment.

Additionally or alternatively, a corresponding clock in the set top box 118 and the environment hub 119 may be synchronized with a common clock in origin server 122 or other source(s) (e.g., a clock server) so that, at about the same time, the set top box 118 may send the content segment and the environment hub 119 may send the control command(s). The set top box 118 may send a synchronization message to the environment hub 119, for example, if the set top box 118 needs additional time to buffer the content segment. The synchronization message may indicate a delay time, where the environment hub 119 may delay sending the control command(s), so that the content segment and control command(s) may be sent out at the same time.

Additionally or alternatively, corresponding clocks in the set top box 118 and the IoT devices 121A-121N may be synchronized with a common clock, for example, in the origin server 122 or other source(s) (e.g., a clock server) so that, the control command(s) may be executed, by the IoT devices 121A-121N, at about the same time with the content segment played by the media player 120. The set top box 118 may send a synchronization message to the IoT devices 121A-121N, for example, if the set top box 118 needs additional time to buffer the content segment. The synchronization message may indicate a delay time, for example, where IoT devices 121A-121N may delay executing the control command(s). The control command(s) may be synchronized such that IoT devices 121A-121N may execute the control command(s) at about the same time.

Additionally or alternatively, at step 405, the origin server 122 may send the manifest file and control file(s) to the set top box 118. The manifest file and control file(s) may be sent to the set top box 118 in combination. The manifest file and control file(s) may be sent to the set top box 118 separately. At step 409, the set top box 118 may forward the manifest file and control file(s) to the environment hub 119, for example, if the set top box 118 detects content properties associated with the environment content type in the manifest file. In one example, control command(s), instead of the control file, may be sent in combination with or separately from the manifest file at step 405. The manifest file and control command(s) may be forwarded at step 409.

At step 427, the media player 120 may play the first content segment. At step 429, the IoT devices 121A-121N may execute the control command(s).

Similar steps (e.g., steps 431-447) may be implemented for the second content segment. The similar steps may be repeated for additional content segments indicated in the manifest file (e.g., steps 449-465 of FIG. 4C for the Nth segment).

FIG. 5 shows an example format of a manifest file. Manifest file 500 may be in Extensible Markup Language (XML), and may comprise manifest header 501, period 503A, period 503B (generally, period 503), content property 505A, content property 505B (generally, content property 505), content segments 507A-1-507A-N, content segments 507B-1-507B-N (generally, content segments 507). The content may be divided by periods 503, and each period 503 of the content may be further divided by segments. The manifest header 501 may comprise metadata or configuration information, for example, included at the top of the manifest file, such as, for example, a namespace, a content identifier, a stream type, a schema location, a profile, a minimum buffer time, a minimum update period, a time shift buffer depth, a maximum segment duration, a publish time, and/or an available start time, etc. The namespace may comprise an identifier for the MPEG-DASH schema. The content identifier may comprise numbers and/or letters identifying the content. The stream type may indicate static (e.g., on-demand) or dynamic (e.g., live). The schema location may indicate a location of the manifest file. The profile may specify the DASH profile used (e.g., live or on-demand). The minimum buffer time may indicate the minimum buffer time applied at a client device (e.g., set top box 118). The minimum update period may indicate an interval at which the client device should check for updates associated with the manifest file. The time shift buffer depth may indicate how far back (e.g., x seconds) the client device may seek in the live stream. The maximum segment duration may indicate a maximum duration of a content segment. The publish time may indicate the time when the manifest was last published or updated. The available start time may indicate the time when the content becomes available for streaming.

The period 503 may comprise an identifier and may further comprise a structural element grouping content streams (e.g., video, audio, environment effect data, etc.). Content property 505 may comprise one or more of an identifier, content type, segment alignment, sub-content type, stream access point (SAP) property, maximum frame height, maximum frame width, maximum frame rate, and/or segment template. The content type may comprise one or more of video, audio, or environment effect data. The content type as environment effect data may indicate an auxiliary data track. The segment alignment may indicate whether content segments across different bitrates are synchronized. The content segments may have substantially similar start and end times if, for example, segment alignment is set to “true.” The sub-content type may specify the subtype of the content. For example, the sub-content type may indicate MP4 for video segments or XML for environment effect data segments. The SAP property may indicate whether a content playback can begin without requiring data from previous segments. The maximum frame height may indicate the maximum frame height for video segments. The maximum frame width may indicate the maximum frame width for video segments. The maximum frame rate may indicate the maximum frame rate for video segments. The segment template may comprise a template for constructing URLs to access content segments. For example, the segment template may indicate a naming pattern for content segments (e.g., videoxx, where xx may indicate a number of content segment). The content segments 507 may indicate a segment index, such as, for example, a segment start time and/or a segment duration.

FIG. 6 shows an example of a manifest file. The example manifest file of FIG. 6 may correspond to the manifest file 500 shown in FIG. 5. FIG. 6 shows an example of auxiliary data track 618. Section 602 shows an example of manifest header, such as a namespace (e.g., http://www.w3.org/2001/XMLSchema-instance), a content identifier (e.g., 4444444444444444163), a stream type (e.g., dynamic), a schema location (e.g., urn:mpeg:dash:schema:mpd:2011 DASH-MPS.xsd), a profile (e.g., urn:mpeg:dash:profile:cmaf:2019, urn:mpeg:dash:profile:isoff-live:2011, http://www.dashif.org/guidelines/low-latency-live-v$), a minimum buffer time (e.g., “PT1S” referring to 1 second of the minimum buffer time), a minimum update period (e.g., “PT1.92S” referring to 1.92 seconds of the minimum update period), a time shift buffer depth (e.g., PT32.002745833S referring to 32.002745833 seconds of the second time shift buffer depth), a maximum segment duration (e.g., “PT2.144041667S” referring to 2.144041667 second of the second maximum segment duration), a publish time (e.g., 2024-05-09T17:15:02.681Z) and/or an available start time (e.g., 1970-01-01T00:00:00Z). Section 604 shows an example of content period with an identifier (e.g., 1715008206251-1) and a duration (e.g., PT476391H10M6.251S”).

Section 606 shows an example of content property for environment effect data, such as an identifier (e.g., id=“0”), a content type (e.g., environment), a segment alignment (e.g., “true” referring that segments in different bitrates are guaranteed to have identical start and end times), a sub-content type (e.g., mimeType=“xml” referring that the environment effect data is in XML format), a stream access point (SAP) property (e.g., startWithSAP=“0” referring that the content stream may not start with an SAP) and a segment template. Content type (e.g., environment) may indicate the following segments (e.g., 614a, 614b, 614c, 614d, etc.) are associated with the environment content.

Section 610 shows an example of video content properties, such as an identifier (e.g., id=“1”), a content type (e.g., video), a video parameter (e.g., “16:9” screen ratio), a segment alignment (e.g., “true” referring that segments in different bitrates are guaranteed to have identical start and end times), a sub-content type (e.g., mimeType=“video/mp4” referring that the video is in mp4 format), a maximum frame height (e.g., “1080” pixels), a maximum frame width (e.g., “1920” pixels), a maximum frame rate (e.g., “30” frame per second), a stream access point (SAP) property (e.g., startWithSAP=“1” referring that the content stream starts with SAP type 1) and a segment template. Content type (e.g., video) may indicate the following segments (e.g., 616a, 616b, 616c, etc.) are associated with the video content.

Section 608 shows an example of segments for environment effect data. Section 612 shows another example of segments for video. The environment effect data segment may be synchronized with the timing of the video/audio segment. For example, segments 614a and 616a may have the same start time and duration. Segment 614b and 616b may start at the time (e.g., t=63999005994). There may be two environment effect data segments within the duration of a single video segment. Segment 614b and 614c may be occurring within the duration of the segment 616b. Segment 614c may end at about the same time as segment 616b. Segment 614d and 616c may be synchronized with the same start time (e.g., t=64000029704).

The segment template may be used to determine paths (e.g., URLs) for requesting control files. For example, auxiliary data track 618 indicates segment template “$RepresentationID$-T-$Time$.xml,” Representation ID “trackId-000,” and time for segments 614a-614d (e.g., t=63999005994). A path for requesting a first control file may be “trackId-000-T-63999005994.xml.” A path for requesting a second control file may be “trackId-000-T-63999517776.xml.”

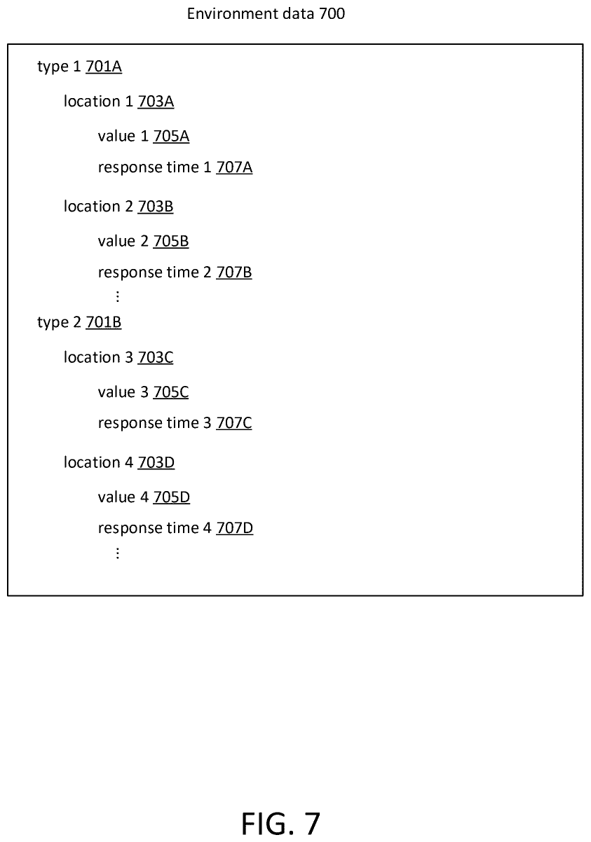

FIG. 7 shows an example format of a control file. The control file 700 may be in an XML or JSON structure. The data of the control file may indicate control data for the IoT devices (e.g., IoT devices 121A-121N) (e.g., user devices) within one segment. Type 701A, and type 701B (generally, type 701) may indicate the type of environment effect data. For example, the type of environment effect data may be luminance level, hue level, seat vibration level, or fragrance dispensing level, etc. Location 703A, location 703B, location 703C, and location 703D (generally, location 703) may indicate a coordination, for example, in polar coordinates, cylindrical coordinates, spherical coordinates, and/or geographic coordinates. The location may indicate an area within a premises where the environment hub (e.g., environment hub 119) is located. The environment hub, for example, based on the type 701 and location 703, may determine which IoT devices should receive the control commands. For example, two IoT devices, such as a lighting device and a fragrance dispenser, may be in the same location. The environment hub, for example, based on the type (e.g., luminance) and location, may determine the lighting device should be receiving the control command for luminance. Value 705A, value 705B, value 705C, value 705D (generally, value 705) may indicate a value of the control data. For example, the value 705 may indicate the level of luminance. Response time 707A, response time 707B, response time 707C, and response time 707D (generally, response time 707) may indicate a delayed time, for example, from the start time of the segment, for example, when the IoT devices execute the control commands.

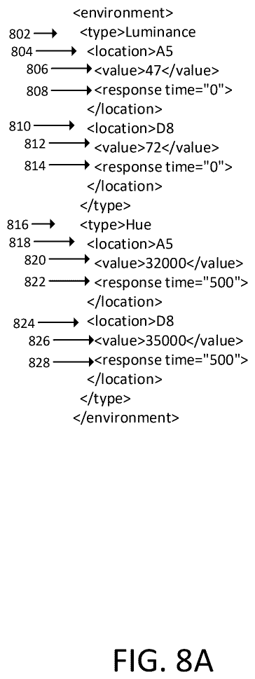

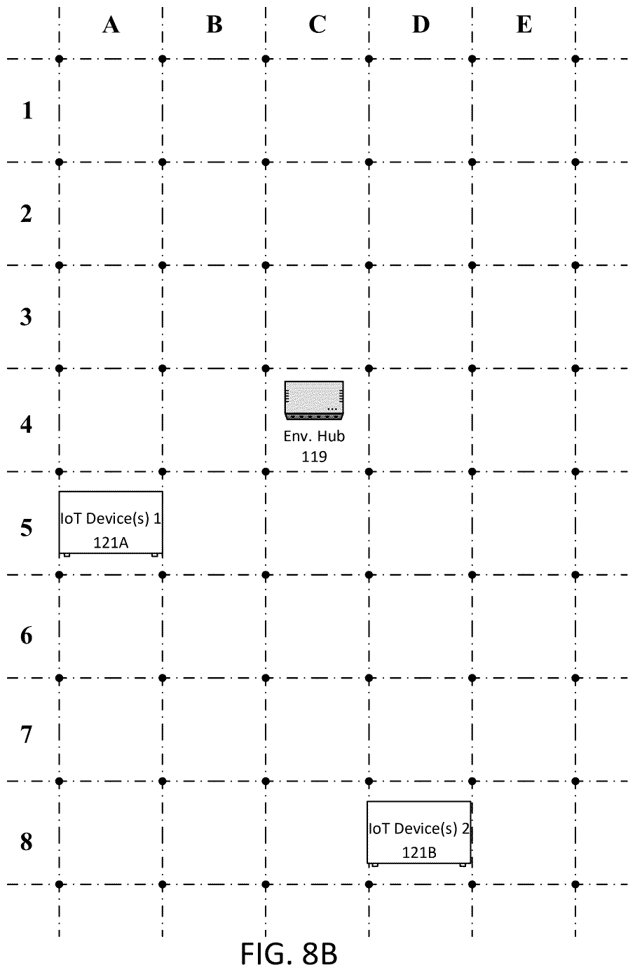

FIG. 8A shows an example of a control file. FIG. 8B shows an example map indicating locations of IoT devices (e.g., user devices) and an environment hub. Value 802 may indicate luminance type. Value 804 may indicate a location (e.g., coordinate A5) of IoT device(s) 121A within the same premises where the environment hub 119 is located, as shown in FIG. 8B. Value 806 may indicate the luminance level be set to 47. Value 808 may indicate the luminance level be set at the start time of the segment, as indicated value “0.” In this example, the environment hub 119 may, at the start time of the segment, send control command(s) to IoT device(s) 121A located at A5 with luminance level 47.

Value 810 may indicate a location (e.g., coordinate D8) of IoT device(s) 121B as shown in FIG. 8B. Value 812 may indicate the luminance level to be set to 72. Value 814 may indicate the luminance level to be set at the start time of the segment, for example, as indicated by value “0.” In this example, the environment hub 119 may, at the start time of the segment, send control command(s) to the IoT device(s) 121B located at D8 with luminance level 72.

Value 816 may indicate Hue type. Value 818 may indicate a location (e.g., coordinate A5) of the IoT device(s) 121A. Value 820 may indicate the hue level to be set to 32000. Value 822 may indicate the luminance level to be set at a delayed time from the start time of the segment, as indicated value “500.” In this example, the environment hub 119 may, at the delayed time (e.g., 500 ms) of the segment, send control command(s) to IoT device(s) 121A located at A5 with hue level 32000.

Value 824 may indicate a location (e.g., coordinate D8) of the IoT device(s) 121B. Value 826 may indicate the hue level to be set to 35000. Value 828 may indicate the luminance level to be set at a delayed time from the start time of the segment, as indicated by value “500.” In this example, the environment hub 119 may, at the delayed time (e.g., 500 ms) of the segment, send control command(s) to IoT device(s) 121B located at D8 with hue level 35000.

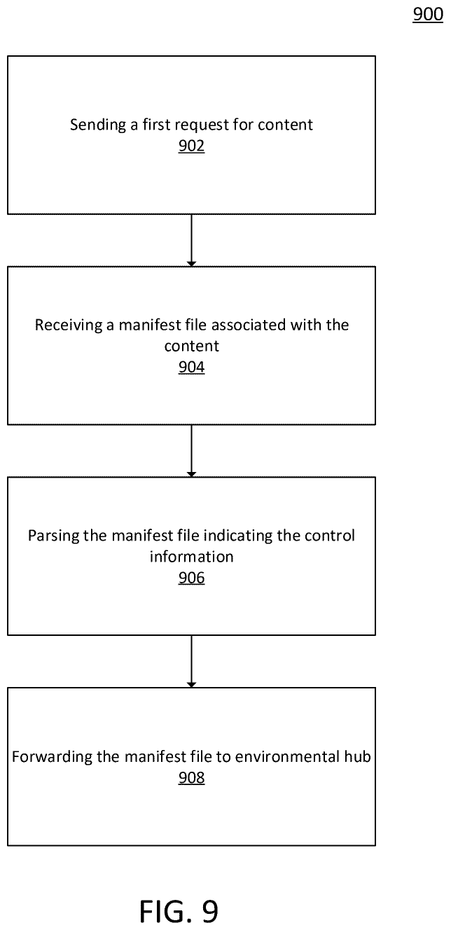

FIG. 9 shows an example method associated with controlling IoT devices (e.g., user devices). One, some, or all steps of the example method 900 of FIG. 9 may be performed by a computing device (e.g., set top box 118 in FIG. 1, FIG. 3A, FIG. 3B, FIG. 3C, FIG. 3D, FIG. 3F, FIG. 4A, FIG. 4B, and FIG. 4C). Also or alternatively, one, some, or all steps of the example method of FIG. 9 may be performed by one or more other computing devices (e.g., computing device 200 in FIG. 2). Steps of the example method of FIG. 9 may be omitted, performed in other orders, and/or otherwise modified, and/or one or more additional steps may be added.

At step 902, a first request may be sent for content. The content may be audio and/or video. The content request (e.g., first request) may comprise one or more identifiers of the content and/or one or more indications of the IoT devices (e.g., associated IoT devices IoT devices 121A-121N shown in FIG. 1, FIG. 3A, FIG. 3B, FIG. 3C, FIG. 3D, FIG. 3E, FIG. 3F, FIG. 3G, FIG. 4A, FIG. 4B, and FIG. 4C). The one or more identifiers of the content may include, for example, a title, a catalog identifier (e.g., comprising numbers and/or letters), and/or a path of the content. The one or more indications of the IoT devices may include, for example, a device type, a device status, and/or a device model number.

At step 904, a manifest file (e.g., manifest file 500 of FIG. 5), for example, associated with the content, may be received. The manifest file may comprise content properties (e.g., content properties 505 of FIG. 5) associated with content types.

At step 906, the manifest file, for example, indicating the control information, may be parsed. Content types may be determined by parsing the manifest file. At step 908, the manifest file may be forwarded to an environment hub (e.g., environment hub 119 shown in FIG. 1, FIG. 3A, FIG. 3B, FIG. 3C, FIG. 3D, FIG. 3E, FIG. 3F, FIG. 3G, FIG. 4A, FIG. 4B, and FIG. 4C) if the content property(ies) associated with the environment content type are detected in the manifest file. The environment hub may send a control file request to the origin server (e.g., origin server 122 shown in FIG. 1, FIG. 3A, FIG. 3B, FIG. 3C, FIG. 3D, FIG. 3E, FIG. 3F, FIG. 3G, FIG. 4A, FIG. 4B, and FIG. 4C), for example, after the environment hub receives the forwarded manifest file. The control files may be used to control IoT devices.

Additionally or alternatively, at step 904, the manifest file and control file(s) may be received. The manifest file and control file(s) may be received in combination. The manifest file and control file(s) may be received separately. At step 908, the manifest file and control file(s) may be forwarded to the environment hub, for example, if content property(ies) associated with the environment content type in the manifest file are detected. In one example, control command(s), instead of the control file(s), may be received in combination with or separately from the manifest file at step 904. The manifest file and control command(s) may be forwarded at step 908.

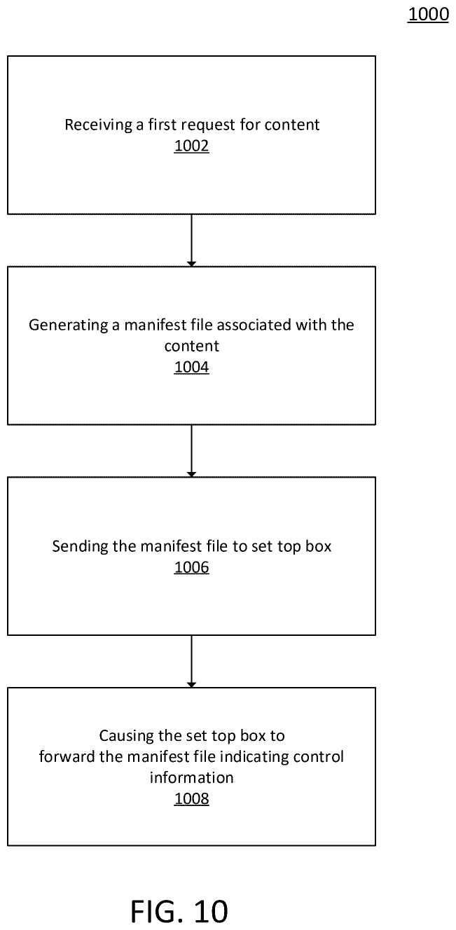

FIG. 10 shows an example method associated with controlling IoT devices (e.g., user devices). One, some, or all steps of the example method 1000 of FIG. 10 may be performed by a computing device (e.g., origin server 122 in FIG. 1, FIG. 3A, FIG. 3B, FIG. 3C, FIG. 3D, FIG. 3E, FIG. 3F, FIG. 3G, FIG. 4A, FIG. 4B, and FIG. 4C). Also or alternatively, one, some, or all steps of the example method of FIG. 10 may be performed by one or more other computing devices (e.g., computing device 200 in FIG. 2). Steps of the example method of FIG. 10 may be omitted, performed in other orders, and/or otherwise modified, and/or one or more additional steps may be added.

At step 1002, a request (e.g., first request) for content may be received. The content may be, for example, audio and/or video. The content request may comprise one or more identifiers of the content, and/or one or more indications of the IoT devices (e.g., IoT devices 121A-121N shown in FIG. 1, FIG. 3A, FIG. 3B, FIG. 3C, FIG. 3D, FIG. 3E, FIG. 3F, FIG. 3G, FIG. 4A, FIG. 4B, and FIG. 4C). The one or more identifiers of the content may include a title, a catalog identifier (comprising numbers and/or letters), and/or a path of the content. The one or more indications of the IoT devices may include a device type, a device status, and/or a device model number.

The content request may be parsed. The requested content and the properties of the IoT devices may be determined by parsing the content request. Content streams may be mapped from content source(s) (e.g., content server 106 as shown in FIG. 1). Content properties (e.g., content properties 505, for example, as shown in FIG. 5) may be defined. The content properties may comprise content output formats, segment durations, content types, resolutions, bandwidths, base content pointers (e.g., URLs), and/or segment indexes. The content type may comprise video, audio, and environment types, where the environment type may be associated with data for controlling the IoT devices. The environment content type may be determined based on the available IoT devices from the parsed content request.

At step 1004, a manifest file (e.g., manifest file 500, for example, as shown in FIG. 5), associated with the content, may be generated. The manifest file may indicate control information for one or more of the IoT devices. The content properties may be used to generate the manifest file. The manifest file may comprise the content properties associated with the content types. The content types may be determined by parsing the manifest file.

At step 1006, the manifest file may be sent to a device (e.g., a set top box 118 in FIG. 1, FIG. 3A, FIG. 3B, FIG. 3C, FIG. 3D, FIG. 3F, FIG. 4A, FIG. 4B, and FIG. 4C), for example, if the content properties associated with the environment content type is detected in the manifest file. At step 1008, the device may be caused to forward the manifest file indicating the control information to an environment hub (e.g., an environment hub 119 shown in FIG. 1, FIG. 3A, FIG. 3B, FIG. 3C, FIG. 3D, FIG. 3E, FIG. 3F, FIG. 3G, FIG. 4A, FIG. 4B, and FIG. 4C). The environment hub may send a control file request to the computing device, for example, after (e.g., based on, if, etc.) the environment hub receives the forwarded manifest file. The control files may be used to control the IoT devices.

Additionally or alternatively, at step 1006, the manifest file and control file(s) may be sent. The manifest file and control file(s) may be sent in combination. The manifest file and control file(s) may be sent separately. At step 1008, the device may be caused to forward the manifest file and control file(s) to the environment hub. In one example, control command(s), instead of the control file(s), may be received in combination with or separately from the manifest file at step 1006. The manifest file and control command(s) may be forwarded at step 1008.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

What is claimed is:

1. A method comprising:
sending, by a first computing device, a first request for content;
receiving, based on the first request, a manifest file associated with the content, wherein the manifest file indicates control information, for one or more user devices, synchronized with the content;
forwarding the manifest file to a second computing device; and
causing, based on the forwarded manifest file, the second computing device to synchronize operations of the one or more user devices with the content.

2. The method of claim 1, wherein the causing the second computing device to synchronize operations of the one or more user devices further comprises causing the second computing device to:
receive, based on the manifest file, one or more control files for controlling the one or more user devices;
generate, based on the one or more control files, one or more control commands for controlling the one or more user devices; and
send the one or more generated control commands.

3. The method of claim 1, further comprising:
sending, by the first computing device and to the second computing device, a second request for a status of the one or more user devices; and
receiving a response comprising information indicating the status of the one or more user devices, wherein the sending the first request is further based on the status of the one or more user devices.

4. The method of claim 1, wherein the causing the second computing device to synchronize the operations of the one or more user devices with the content further comprises causing the second computing device to:
determine a status of the one or more user devices;
send, based on the status and to a server device, a third request of at least one control file for the one or more user devices; and
receive, based on the third request and from the server device, the at least one control file.

5. The method of claim 1, wherein the forwarding the manifest file causes the second computing device to:
determine a status of the one or more user devices; and
send, based on the status and to the one or more user devices, at least one control command.

6. The method of claim 1, wherein the forwarding the manifest file causes the second computing device to:
receive one or more control files, wherein:
the one or more control files are used to generate one or more control commands; and
the one or more control commands are associated with at least one user device type; and
send, based on the at least one user device type and to the one or more user devices, the one or more control commands.

7. The method of claim 1, wherein the forwarding the manifest file causes the second computing device to:
determine a threshold associated with the one or more user devices; and
send one or more control commands to the one or more user devices, wherein the one or more control commands indicate a setting below or equal to the threshold.

8. A method comprising:
receiving, by a first computing device and from a second computing device, a manifest file associated with content, wherein:
the second computing device is configured to, based on the manifest file, request content segments, and output the content segments; and
the manifest file indicates control information, for one or more user devices, synchronized with the content;
receiving, based on the manifest file, one or more control files for controlling the one or more user devices;
generating, based on the one or more control files, one or more control commands for controlling the one or more user devices; and
sending, to the one or more user devices, the one or more control commands, wherein the one or more control commands comprises one or more commands to control one or more environment effects.

9. The method of claim 8, wherein the generating one or more control commands is further based on a status of the one or more user devices.

10. The method of claim 8, further comprising:
receiving a message indicating a delay time,
wherein the sending the one or more control commands further comprises:
sending the one or more control commands after a time period corresponding to the delay time.

11. The method of claim 8, wherein:
the manifest file comprises data associated with one or more of:
a video content type;
an audio content type; or
an environment type,
wherein the data associated with the environment type indicates the control information.

12. The method of claim 8, wherein:
the manifest file comprises auxiliary data track; and
the auxiliary data track indicates time information for synchronizing with the content.

13. The method of claim 8, wherein the one or more environment effects comprises at least one of:
a luminance level;
a hue level;
a seat vibration level; or
a fragrance dispensing level.

14. A method comprising:
receiving, by a server device and from a first computing device, a first request for content;
generating, based on the first request, a manifest file comprising:
information associated with segments of the content; and
control information configured to cause one or more user devices to output an environment effect, synchronized with the content; and
sending, to the first computing device, the manifest file.

15. The method of claim 14, wherein:
the first request comprises an indication of a status of the one or more user devices; and
the generating the manifest file further comprises:
generating, based on the status of the one or more user devices, the manifest file.

16. The method of claim 14, further comprising:
receiving, by the server device, a second request for one or more control files associated with the one or more user devices, wherein the second request indicates a segment index associated with the content; and
sending, based on the segment index, the one or more control files.

17. The method of claim 14, further comprising:
causing the first computing device to:
based on the manifest file, request content segments, and output the content segments;
determine that the manifest file indicates the control information; and
forward, based on the determining and to a second computing device, the manifest file.

18. The method of claim 14, wherein the sending the manifest file causes the first computing device to forward, to a second computing device, the manifest file; and
wherein the forwarding the manifest file further causes a second computing device to:
determine a status of the one or more user devices; and
receive, based on the status, one or more control files for the one or more user devices, wherein the one or more control files are used for generating one or more control commands for managing the one or more user devices.

19. The method of claim 14, further comprising
storing, by the server device, a control file, wherein the control file is used for generating one or more control commands for controlling the one or more user devices;
receiving a second request for modifying the control file; and
modifying, based on the second request, the control file.

20. The method of claim 14, wherein the control information is associated with one or more commands to control one or more of:
a luminance level;
a hue level;
a seat vibration level; or
a fragrance dispensing level.
